(19) United States
(12) Patent Application Publication
(10) Pub. No.: US 2008/0107479 A1
(43) Pub. Date: May 8, 2008

(54) Fan fixing apparatus

(75) Inventor: Chun-Yu Yang, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/593,505

(22) Filed: Nov. 7, 2006

(51) Int. Cl. F16J 1/16

(52) U.S. Cl. 403/155

(57) ABSTRACT

A fan fixing apparatus is provided. The fan fixing apparatus clamps the fan and positions the fan on the casing. The fan fixing apparatus includes a plurality of mushroom pillars and a frame. The mushroom pillars are disposed on the casing, and the frame has a clamping portion for clamping the fan and a plurality of gourd holes corresponding to the mushroom pillars. The gourd hole has a guiding portion, a positioning portion and a slide rail communicating the guiding portion and the positioning portion. The mushroom pillar is inserted into the guiding portion, and is finally positioned in the positioning hole by moving along the slide rail, such that the fan fixing apparatus is rapidly positioned in the casing.

### BACKGROUND OF THE INVENTION

1. Field of Invention

The present invention relates to a fan fixing apparatus. More particularly, the present invention relates to a fixing apparatus capable of positioning the fan on the casing rapidly by using the relative displacement between the mushroom pillars and the gourd holes.

2. Related Art

No matter what kinds of electronic equipments or computer equipments, a same problem, i.e., dissipation of the thermal energy, exists during booting and operation. As people seek for the convenience in using, the necessary functions and the achievable performance required by the equipment itself are increasingly improved. Correspondingly, the internal functional circuits of the electronic elements, such as the processing chip, contained in the casing of the equipment increase, so the power consumption and the heating power of the electronic elements increase correspondingly, thus the internal temperature of the casing gradually increases. However, the overhigh temperature may affect the normal operation of the electronic elements, and more seriously, the electronic elements may be burnt. Therefore, it is a common topic for the people in the industry that how to maintain the internal stable temperature of the casing.

However, in order to solve the heat dissipation problem, usually the people engaged in the industry may dispose a heatsink fan at the position of the air vent or where the thermal energy generates of the casing, so as to perform the air convection enforcedly to exhaust the hot air from the casing. As for the past, the used manners of fixing the heatsink fan on the casing include the following types.

(1) The fan is directly fixed on the casing by screwing. In the method, a plurality of corresponding threaded holes is respectively disposed on the fan and the casing, and then a plurality of screws is used to tightly adhere and fix the fan on the casing by screwing. Moreover, the cap nuts may be added to assist screwing, and the fan supporting frame is added to assist the positioning of the fan, so as to avoid the loosing of the screws or the moving of the fan due to collision of the casing.

(2) The fixing apparatus is used to assist the fan to be fixed on the casing. In the method, supporting rib or plastic board is used to fabricate the frame surrounding the fan, or the housing for accommodating the fan is formed, a plurality of buckling latches or buckling hooks is disposed around the frame or the housing, and corresponding buckling holes or inserting holes are disposed on the casing for providing the buckling latches or the buckling hooks to buckle, such that the fan may be fixed on the casing by the fixing apparatus. However, in addition to the buckling manner, the fixing apparatus may also be fixed on the casing by screwing, the corresponding threaded holes are disposed on the fixing apparatus and the casing, and then the fixing apparatus is screwed on the casing by the screws.

However, the prior art has the following unavoidable disadvantages.

(1) It is difficult to replace. If the screwing manner is used to fix the fan, no matter when the fan itself or the fixing apparatus is disposed or disassembled, the assistant tools are required, such as screw driver or wrench, so as to screw or unscrew the screws used for fixing. If the fan fails and the tool does not exist, it is impossible to perform the disassembling operation to replace a new fan. Next, for the buckling structure, the buckling hooks are usually fixed on the buckling holes by fluke buckling, and additionally tools are required for assisting during disassembling. If the assistant tools are not used, usually the buckling structure is destroyed due to incorrect manner of force application.

(2) The assembling parts are complicated. No matter for the screwing manner or the buckling manner, assembling a single fan or using the fixing apparatus to assist the positioning of the fan, a plurality of parts is required for the fixing operation. For example, the screwing manner needs a plurality of screws or cap nuts, and according to different situations, the parts such as the fan supporting frame or the outer frame mask are required for assisting positioning. The recognition of the function of the parts spends a lot of time, and performing assembling operation with various kinds of parts may spend more. Moreover, if a part is not assembled, the fan is not fixed firmly enough, thus resulting in the displacement situation.

### SUMMARY OF THE INVENTION

Accordingly, the problem to be solved by the present invention is to provide a fan fixing apparatus which can be stably positioned on the casing without using the assistant tool, and without too many complicated assembling parts.

In order to solve the problem of the prior art, the present invention provides a fan fixing apparatus for clamping at least one fan and stably positioning the fan on a casing.

The fan fixing apparatus comprises a plurality of mushroom pillars and a frame. The mushroom pillars are firstly disposed on the casing, each mushroom pillar comprises two parts, a mushroom head portion and a mushroom column portion, and the outer diameter of the mushroom head portion is larger than that of the mushroom column portion. The frame has a clamping portion and a plurality of gourd holes. The clamping portion is used to clamp the fan in the frame, and the disposing position of the gourd holes respectively corresponds to each mushroom pillar. The gourd hole comprises three parts, a guiding portion, a positioning portion and a slide rail. The slide rail is used to communicate the guiding portion and the positioning portion, and the aperture of the guiding portion is larger than the outer diameter of the mushroom head portion. When positioning the frame, all the mushroom pillars are respectively aligned with each gourd hole exactly and are inserted into the guiding portions, then, the mushroom pillars are moved to the positioning portions through the slide rail, and are finally stopped and positioned in the positioning portions. The frame may form the positioned state correspondingly.

In order to enhance the positioning effect of the fan fixing apparatus, a snapping module may be added on the whole apparatus. A supporting block is disposed on the casing, and a snapping member is disposed on the surface of the frame facing the supporting block. When the frame finishes the positioning action, the snapping member is snapped with the supporting block, thereby forming the force for keeping the mushroom pillar be positioned in the positioning portion, so as to enhance the positioning effect of the frame.

A fan fixing apparatus provided by the present invention has the following functions and capabilities better than that of the prior art.

(1) The replacement of the fan is easier and more convenient. In the conventional art, the screwing or buckling manner is used for fixing, and usually the assistant tool is required, for example the screw driver is required by the screw latching, such that the assembling or disassembling operation of the fan is quite time consuming and painstaking. However, with the fan fixing apparatus of the present invention, it is only required to insert the mushroom pillars into the gourd holes, and move them to the positioning portions, thus finishing the position of the frame. The snapping module may be further added to keep the mushroom pillar be positioned by the force generated by snapping, so it is more convenient than the conventional art.

(2) The time cost is saved. In the conventional art, when the fan is fixed, usually additional parts, such as the fan supporting frame or the outer frame mask are required to be assembled to assist fixing the fan. However, the fan fixing apparatus of the present invention does not need to assemble the complicated parts, and all the functions of the components may be easily known from the appearance, so as to perform positioning. Even if the adding of the snapping module only needs a snapping action additionally to finish the positioning of the fan fixing apparatus, therefore, the time for the user to recognize the function of the element and to assemble the element is significantly saved.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1A is an exploded view of the fan fixing apparatus of the present invention;

FIG. 1B is a detailed view of the gourd hole “a” of the present invention;

FIG. 1C is a detailed view of the mushroom pillar of the present invention;

FIG. 1D is a detailed view of the clamping portion of the present invention;

FIG. 2 is a view of the displacement of the fan fixing apparatus of the present invention;

FIG. 3 is a schematic view of the positioning of the fan fixing apparatus of the present invention;

FIG. 4A is an exploded view of the fan fixing apparatus of the present invention;

FIG. 4B is a detailed view of the gourd hole “b” of the present invention;

FIG. 5 is a view of the displacement of the fan fixing apparatus of the present invention;

FIG. 6 is a schematic view of the positioning of the fan fixing apparatus of the present invention;

FIG. 7 is an arrangement view of the compression spring of the present invention; and

FIG. 8 is a one-piece disposing view of the mushroom pillar of the present invention.

### DETAILED DESCRIPTION OF THE INVENTION

In order to make a further understanding of the object, the construction feature and the function of the present invention, it is described with the relative embodiments and the drawings as follows.

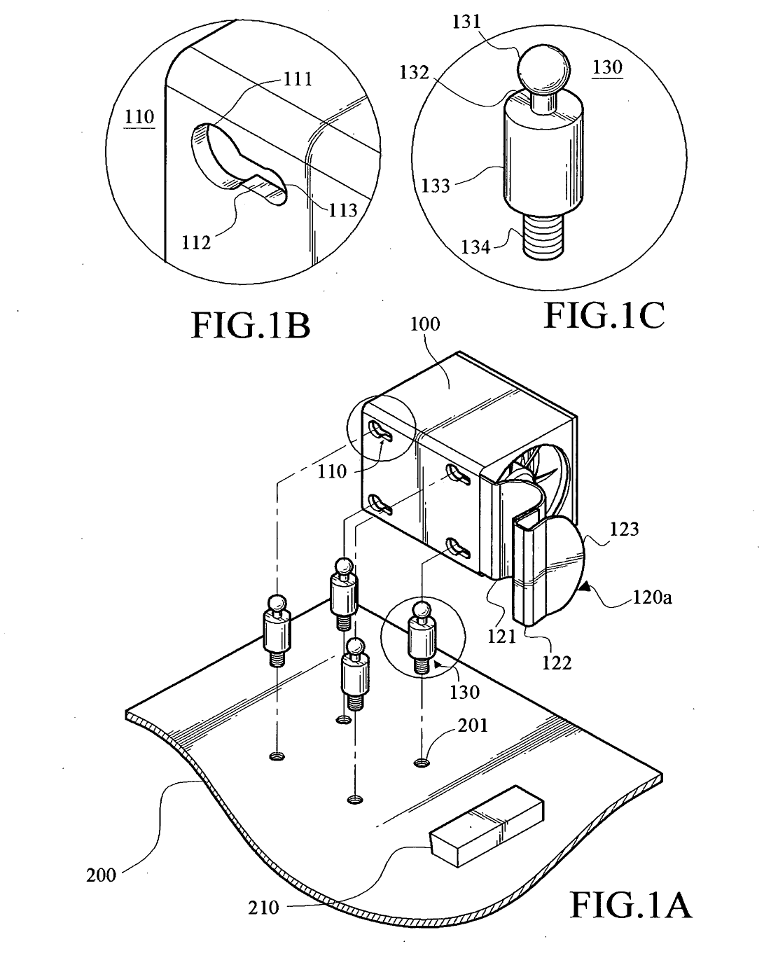

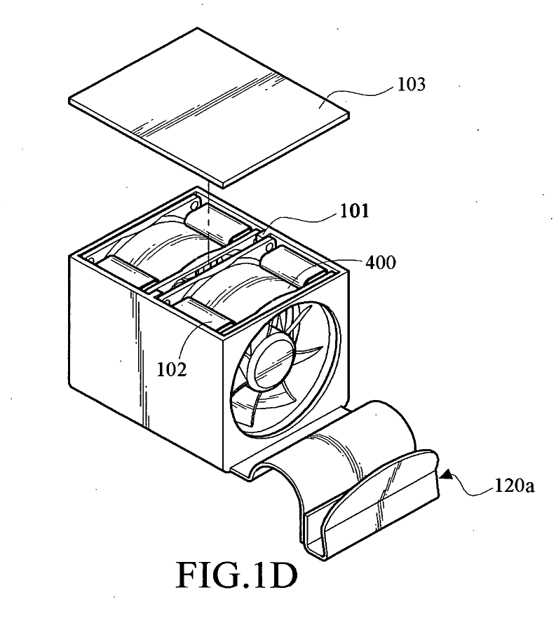

As shown in FIGS. 1A to 1D, the structural view of the fan fixing apparatus and the detailed views of part of the elements of the present invention are shown. The fan fixing apparatus includes a frame 100, a snapping member 120a, a plurality of mushroom pillars 130 and a supporting block A 210. The frame 100 has a clamping portion (formed by a spacing strip 101 and an elastic clamping piece 102) for clamping the fan 400. The spacing strip 101 is used to separate the inner space of the frame 100 to form a plurality of accommodation slots, and the elastic clamping piece 102 is used to clamp and fix the fan 400 in the accommodation slot, and the top cover 103 is shut to seal the opening of the frame 100, so as to finish the fan clamping operation. However, the fan 400 clamped by the frame 100 may be different kinds of heatsink fans, such as an axial flow fan or a direct flow fan. Therefore, an air vent corresponding to the air flow path of the fan 400 is disposed on the frame 100, thereby smoothing the air flow of the fan 400. A plurality of gourd holes A 110 is disposed on the bottom of the frame 100, and the gourd hole A 110 includes a guiding portion A 111, a positioning portion A 113 and a slide rail A 112 communicating the guiding portion A 111 and the positioning portion A 113.

In this embodiment, the snapping member 120a is combined with an elastic metal plate 121, a supporting board 122 and a pick-up handle 123. One end of the elastic metal plate 121 is connected to the frame 100, the other end extends to be connected to the supporting board 122, and the pick-up handle 123 is disposed above the supporting board 122. The supporting block A 210 corresponding to the snapping member 120a is disposed on the casing 200. A plurality of threaded holes 201 is disposed on the casing 200, and the disposing position of the threaded hole 201 corresponds to the disposing position of the gourd hole A 110. Moreover, the mushroom pillar 130 includes a mushroom head portion 131 and a mushroom column portion 133, and the connecting position between the two portions shrinks inward to form a mushroom neck portion 132. A bolt 134 is disposed at the bottom of the mushroom pillar 130, for screwing the mushroom pillar 130 to the threaded hole 201, such that the mushroom pillar 130 corresponds to the gourd hole A 110. Both of the width of the slide rail A 112 and the aperture of the positioning portion A 113 are between the outer diameter of the mushroom neck portion 132 and the outer diameter of the mushroom head portion 131 and less than the outer diameter of the mushroom column portion 133, and the aperture of the guiding portion A 111 is larger than the outer diameter of the mushroom head portion 131.

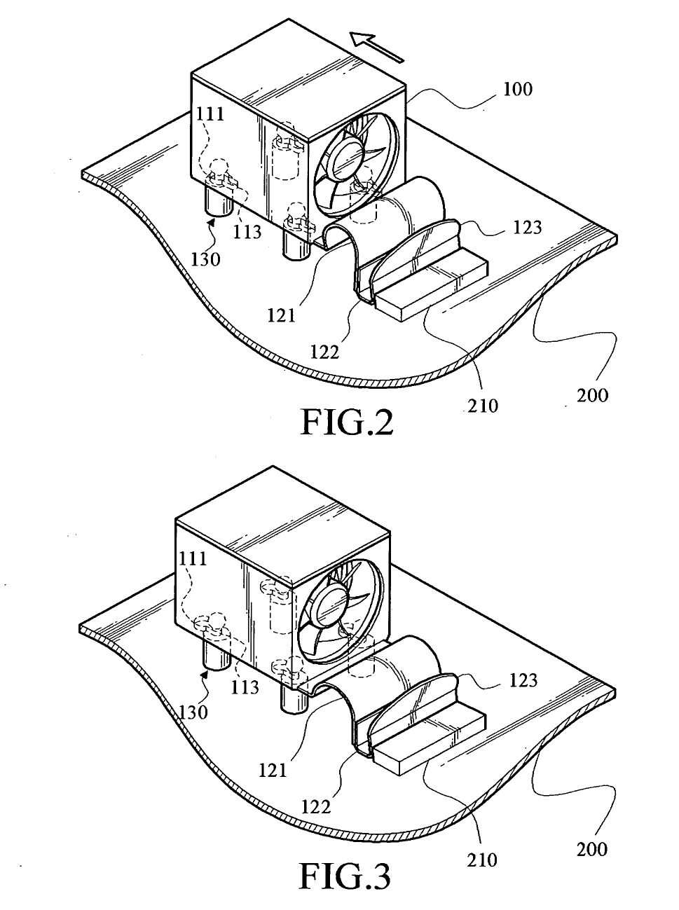

As shown FIG. 2, it is a view of the displacement of the fan fixing apparatus of the present invention. The mushroom pillar 130 corresponds to the gourd hole A 110 and inserts to the guiding portion A 111. After inserting into the guiding portion A 111, the mushroom pillar 130 slides towards the direction of the positioning portion A 113 through the slide rail A 112.

As shown in FIG. 3, it is a schematic view of the positioning of the fan fixing apparatus of the present invention. When the mushroom pillar 130 is positioned in the positioning portion A 113, a stopping surface of the supporting board 122 is against the supporting block A 210, so as to generate a force keeping the mushroom pillar 130 to be positioned, thereby making the frame 100 continue to be in the positioning state. However, if the fan fixing apparatus is to be disassembled, only the pick-up handle 123 is wrenched to make the stopping surface of the supporting board 122 form the non-stopping state with the supporting block A 210, such that the mushroom pillar 130 may move between the guiding portion A 111 and the positioning portion A 113, and the mushroom pillar 130 is separated from the guiding portion A 111, thereby disassembling the frame 100 from the casing 200.

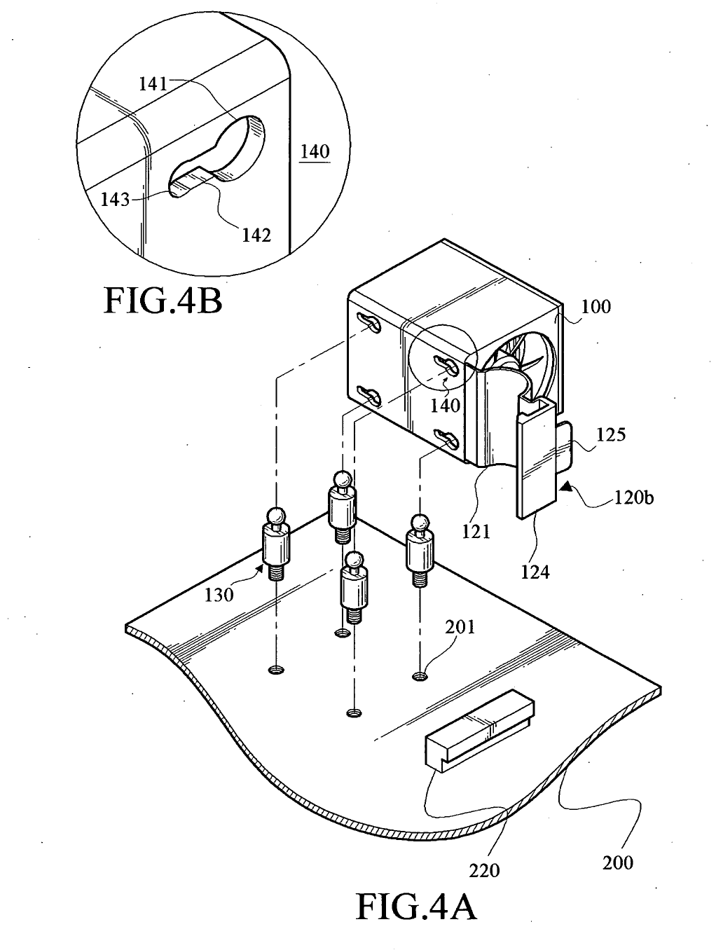

As shown in FIGS. 4A and 4B, a structural view of the fan fixing apparatus of the present invention and a detailed view of a part of the elements of the present invention are shown, and please view FIGS. 1A and 1B together for better understanding. The supporting board 122 of the snapping member 120a is changed to a buckling hook 124 to form a snapping member 120b, and the disposing direction of the guiding portion B 141 and the positioning portion B 143 of the gourd hole B 140 is different from that of the gourd hole A 110 of FIG. 1, but a slide rail B 142 is still disposed between the two portions for communicating them. It is disposed according to the direction of the force correspondingly keeping the positioning of the frame 100, when the buckling hook 124 buckles the supporting block B 220. Next, in order to accord with the structure of the buckling hook 124, the formerly disposed block type supporting block A 210 is changed to the groove type supporting block B 220, so as to match the bucking action of the bucking hook 124.

As shown in FIG. 5, and comparing with FIG. 2 for better understanding, it is a view of the displacement of the fan fixing apparatus of the present invention. The mushroom pillar 130 corresponds to the gourd hole B 140 and inserts to the guiding portion B 141. After inserting into the guiding portion B 141, the mushroom pillar 130 slides towards the direction of the positioning portion B 143 through the slide rail B 142. However, the disposing direction of the gourd hole B 140 is different from that of the gourd hole A 110, thus the direction of the displacement of the frame 100 is different from the direction shown in FIG. 2.

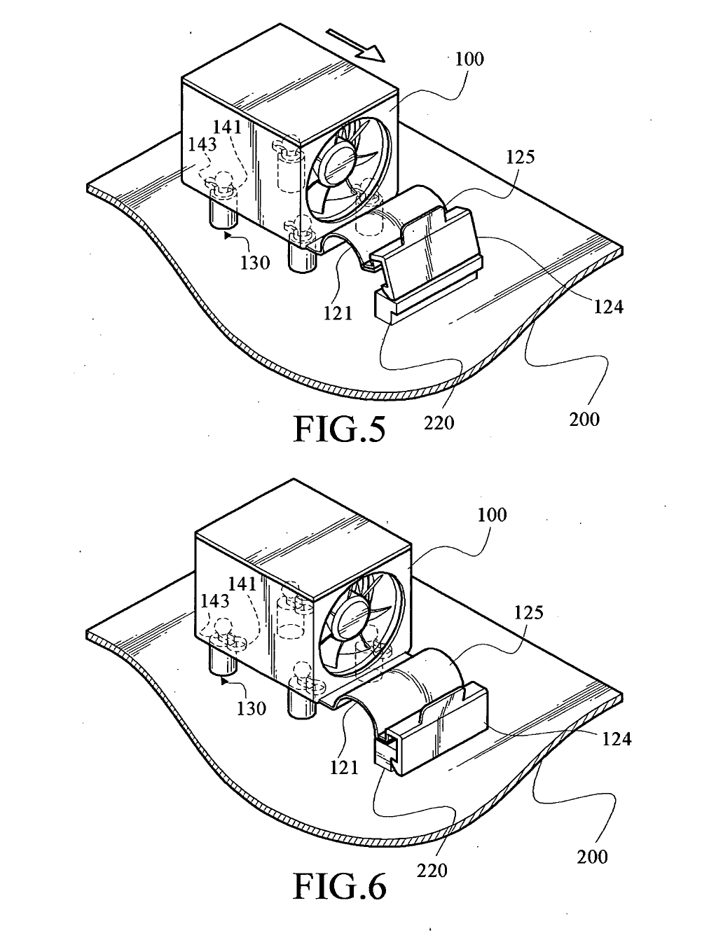

As shown in FIG. 6, it is a schematic view of the positioning of the fan fixing apparatus. When the mushroom pillar 130 is positioned in the positioning portion B 143, the buckling hook 124 buckles the supporting block B 220, so as to generate a force keeping the mushroom pillar 130 to be positioned. However, if the fan fixing apparatus is to be disassembled, only the pick-up handle 125 is wrenched to release the buckling state between the buckling hook 124 and the supporting block B 220, such that the mushroom pillar 130 may move between the guiding portion B 141 and the positioning portion B 143, and the mushroom pillar 130 is separated from the guiding portion B 141, thereby disassembling the frame 100 from the casing 200.

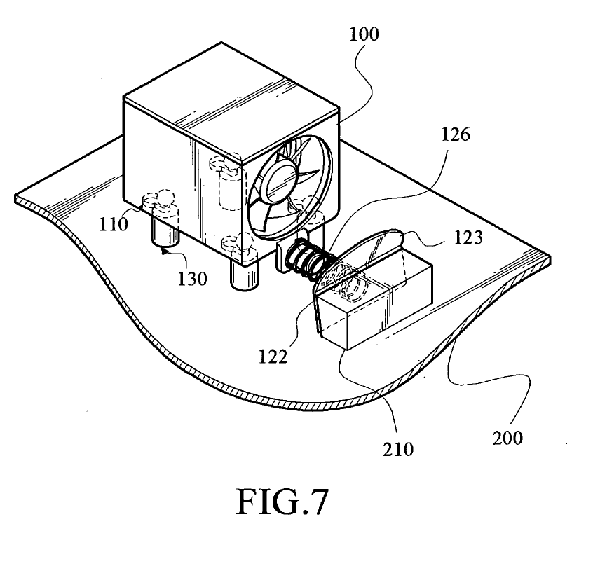

As shown in FIG. 7, the elastic metal plate 121 mentioned in the above drawings may be changed to a compression spring 126, and the generated performance is the same as the performance generated by using the elastic metal plate 121.

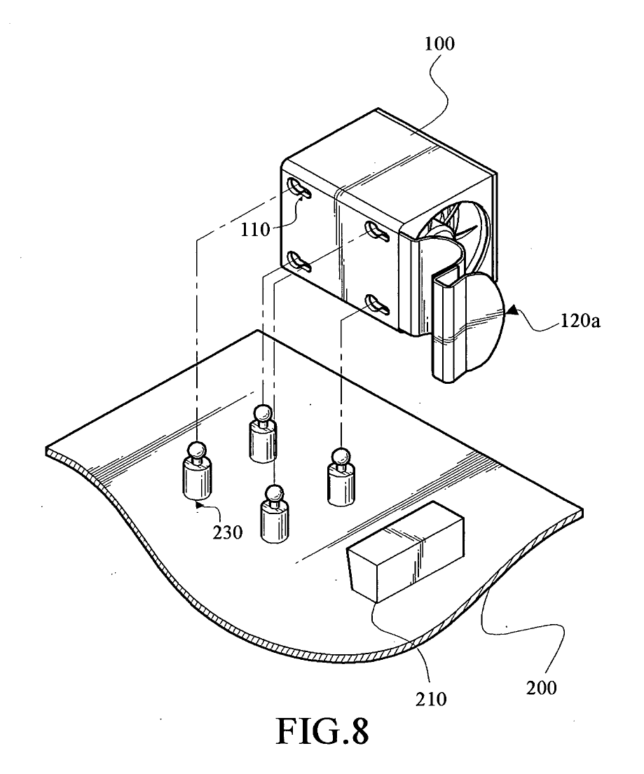

The mushroom pillars 130 are disposed by screwing as described above, in addition, they can be formed by directly extending from the casing 200. As shown in FIG. 8, the mushroom pillars 230 are directly formed directly on the casing 200. Similarly, the mushroom pillars 230 may also be formed by extending from the frame 100, and the corresponding gourd holes may be disposed on the casing 200.

The present invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A fan fixing apparatus, for clamping at least one fan and fixing the fan on a casing, comprising:
a plurality of mushroom pillars disposed on the casing, wherein the mushroom pillar is formed by a mushroom head portion and a mushroom column portion, and the outer diameter of the mushroom column portion is less than that of the mushroom head portion; and
a frame, comprising a clamping portion for clamping the fan, and a plurality of gourd holes corresponding to the mushroom pillars, wherein the gourd hole has a guiding portion, a positioning portion, and a slide rail communicating the guiding portion and the positioning portion, the gourd hole is provided for the mushroom pillar to pass through the guiding portion, to move along the slide rail and to be positioned in the positioning portion.

2. The fan fixing apparatus as claimed in claim 1, wherein the aperture of the positioning portion and the width of the slide rail are between the outer diameter of the mushroom head portion and the outer diameter of the mushroom column portion, and the aperture of the guiding portion is larger than the outer diameter of the mushroom head portion.

3. The fan fixing apparatus as claimed in claim 1, wherein a connecting position of the mushroom head portion and the mushroom column portion shrinks inward to form a mushroom neck portion, the width of the slide rail and the aperture of the positioning portion are between the outer diameters of the mushroom neck portion and the mushroom head portion, and the aperture of the guiding portion is larger than the outer diameter of the mushroom head portion.

4. The fan fixing apparatus as claimed in claim 1, wherein the casing further comprises a supporting block, and the frame further comprises a snapping member for snapping the supporting block, so as to generate a force for keeping the mushroom pillar be positioned in the positioning portion.

5. The fan fixing apparatus as claimed in claim 4, wherein the snapping member comprises:
an elastic member, with one end connected to the frame; and
a supporting board, extending from the elastic member and having a stopping surface being against the supporting block, wherein when the stopping surface is against the supporting block, the elastic member has a force keeping the mushroom pillar be positioned in the positioning portion.

6. The fan fixing apparatus as claimed in claim 5, wherein the elastic member is an elastic metal plate or a compression spring.

7. The fan fixing apparatus as claimed in claim 5, wherein the supporting board further comprises a pick-up handle, for moving the stopping surface and making the stopping surface in the state of not being against the supporting block.

8. The fan fixing apparatus as claimed in claim 4, wherein the snapping member comprises:
an elastic member, with one end connected to the frame; and
a buckling hook, disposed at another end of the elastic member, for buckling the supporting block and keeping the mushroom pillar be positioned in the positioning portion.

9. The fan fixing apparatus as claimed in claim 8, wherein the elastic member is an elastic metal plate or a compression spring.

10. The fan fixing apparatus as claimed in claim 8, wherein the buckling hook further comprises a pick-up handle, for moving the buckling hook and making the buckling hook and the supporting block in a non-buckling state.
